(19) United States
(12) Patent Application Publication
(10) Pub. No.: US 2007/0138763 A1
(43) Pub. Date: Jun. 21, 2007

(54) Lock for trailer hitch

(76) Inventor: Edward St. George, Isla Vista, CA (US)

Correspondence Address: Michael G. Petit, P. O. Box 91929, Santa Barbara, CA, 93190-1929, US

(21) Appl. No.: 11/303,161

(22) Filed: Dec. 15, 2005

(51) Int. Cl. E05B 65/00; B60D 1/60

(52) U.S. Cl. 280/507; 70/57

(57) ABSTRACT

A lock for a trailer hitch is disclosed. The locking device is a substantially spherical member dimensioned to fit within the socket of a ball and socket-type trailer hitch. When a trailer tongue is detached from the ball on a towing vehicle, an unauthorized party may connect the trailer to a towing ball on another vehicle and steal the trailer and any property attached to or supported by the trailer. The present invention provides a locking device that lockingly engages the socket in a detached trailer hitch thereby occluding the socket and preventing the attachment of a towing ball thereto until the locking device is removed from the socket by an authorized party with the use of a key.

### BACKGROUND OF THE INVENTION

1. Field of the Invention

The present invention relates to a locking device operable for preventing theft of a trailer having a ball-and-socket type tow connector on the tongue thereof.

2. Prior Art

The present invention is directed to an anti-theft device for a trailer having a trailer hitch generally characterized as a ball and socket type of mounting system. The ball is supported by a tow bar attached to a vehicle, while the socket comprises a substantially hemispherical receptical disposed on the tongue of a trailer, the socket being dimensioned to receive the ball therewithin. The trailer hitch normally further includes locking means operable for lockingly engaging the ball within the socket. It is estimated that over ten million vehicles in the United States are equipped with trailer hitches—almost all trucks, recreational vehicles and pickups are so equipped. Accordingly, there are a large number of trailers having hitching devices thereon adapted to matingly and lockingly engage a ball mounted on such vehicles.

Many devices have been disclosed that are operable for preventing unauthorized detachment of a trailer that is hitched to a vehicle. For example, Irgens et al., in U.S. Pat. No. 6,846,002 disclose a lock assembly for use with conventional trailer locks that is operable for securing a trailer hitch to a ball. The lock includes a housing portion that secures the threaded portion of the hitch ball and prevents removal of the hitch ball when the hitch ball is engaged and locked by the trailer hitch coupler.

Trailers, such as boat trailers, utility trailers, construction equipment trailers, military trailers, and camping trailers, are typically left unattended for long periods of time and accordingly are vulnerable to theft. U.S. Pat. Nos. 3,780,546, 3,844,143, 3,884,055, 4,186,575, 4,440,005, 4,480,450, 4,577,884, 4,581,908, 4,730,841, 4,774,823, 4,836,570, 5,063,759, 5,195,339, 5,332,251, 5,343,720, 5,743,549, 5,752,398, 5,775,139, 5,794,961, 5,873,271, 5,937,679, 6,070,441, 6,202,453, and 6,405,569 each describe anti-theft devices for trailers, but none of these patents teach or suggest a ball and socket-type hitch lock according to the present invention.

The most commonly used trailer hitches are the ball and socket-type and the ball and ring-type. Witchey, in U.S. Pat. No. 6,698,256, discloses a ball and ring hitch lock operable for reversibly obstructing a ball socket or ring of a trailer hitch in order to prevent the theft of an unhitched trailer. The ball and ring hitch lock comprises an upper plate and a base plate. The upper plate has a lower surface, and first and second opposing ends, with a post that extends in a normal direction from the lower surface of the upper plate. The post has a plurality of notches defined therein. The base plate has an upper surface and a sleeve with a hollow bore. The sleeve extends in a normal direction through the base plate and has a side opening defined therein. The sleeve is sized to accommodate the post extending from the upper plate. A lock mechanism is disposed in the base plate.

The lock mechanism has at least one catch. When the lock mechanism is in a locked position the at least one catch extends into the side opening of the sleeve to engage at least one of the notches defined in the post in order to prevent removal of the base plate from the post. When the lock mechanism is in an unlocked position, the catch retracts from the sleeve in order to permit removal of the base plate from the post. A male member is attached to the upper surface of the base plate. The male member is sized to fit into a ball or a ring type hitch.

As mentioned above, unhitched trailers are highly susceptible to theft. A thief can easily connect a trailer hitch to a pickup truck or the like, and pull the trailer away. Socket-type trailer hitches are particularly vulnerable wherein a tow ball on a thieves' truck may be as compatible with the socket of the hitch as the tow ball on the trailer owner's vehicle. To prevent such theft, Kite, in U.S. Pat. No. 6,405,569, discloses a theft prevention lock for trailers with socket-type hitches. The locking device has a first plate element having a base portion and inner and outer ends. An upwardly extending arcuate protrusion is formed on the inner end of the first plate to penetrate the socket of a trailer hitch through the open bottom of the socket. The device includes upper and lower plates that are pivotally attached to one another. The shape of the first and second plates is such that when a socket-shaped portion of the lower plate is pivoted relative to the upper plate, the socket-shaped portion enters the socket thereby occluding the socket and preventing the insertion of a ball thereinto. Apertures in the plate elements are in a registered position permitting the device to be affixed into a locked position with a padlock extending through the registered apertures in the first and second plates. A disadvantage of the device is that the padlock can be easily removed with a lock cutter.

The locking devices of the prior art each have some disadvantage. Most are unduly difficult to use or are expensive to manufacture. Others are easily removed with standard tools. There remains a need for a locking device that is easy to install and operate, difficult to remove without a customized key, and operable for protecting a trailer having a socket-type hitch from theft.

### SUMMARY

The present invention is directed to a locking device for a trailer hitch and a method for using the locking device for preventing the theft of a trailer that substantially obviates one or more of the limitations of the related art. To achieve these and other advantages and in accordance with the purpose of the invention, as embodied and broadly described herein, the invention includes an expandable member dimensioned to fit within the socket of a trailer hitch. After the locking device is inserted within the socket, a customized key is employed to expand the locking device within the socket to lockingly engage the device within the socket such that the locking device cannot be removed from the socket without the customized key which may be removed from the device after expansion thereof.

More particularly, the present invention discloses a locking device operable for occluding a socket in a trailer hitch wherein the socket is adapted to matingly engage a spherical towing ball. The locking device comprises an expandable member, a locking assembly and a key. The expandable member is a substantially spherical, segmented body that is adapted to fit within the socket of a trailer hitch. The expandable member has an axial bore that is tapered outwardly on both ends thereof. The tapered portions of the axial bore are substantially conical and have a greatest diameter. The locking assembly is an elongate member adapted to fit within the axial bore, the locking assembly thereafter providing means for expanding the expandable member outwardly when the key engages the locking assembly and is rotated. The locking assembly includes a fixed bolt having a tapered head and a threaded shaft projecting therefrom, and a threaded nut adapted to matingly engage the threaded shaft and having a tapered outer surface. The tapered outer surfaces of the head of the fixed bolt and the threaded nut are substantially conical and have a greatest diameter that is greater than the greatest diameter of the tapered portions of the axial bore. In operation, the expandable member is placed within a trailer hitch socket and the locking assembly is disposed within the axial bore. As the threaded nut, which is engaged by the key, is advanced by rotation on the threaded shaft toward the head of the fixed bolt, the tapered outer surfaces of the fixed bolt and the threaded nut press against the tapered portions of the wall of the axial bore and urge the segments comprising the expandable member radially outwardly to press firmly against the wall of the socket. The key is then removed from engagement with the threaded nut. The expandable member cannot be removed from the socket without the use of the key.

The features of the invention believed to be novel are set forth with particularity in the appended claims. However the invention itself, both as to organization and method of operation, together with further objects and advantages thereof may be best understood by reference to the following description taken in conjunction with the accompanying drawings.

### BRIEF DESCRIPTION OF THE DRAWINGS

FIG. 1 is a perspective view of a locking device in accordance with the present invention with the key removed from the lock.

FIG. 2 is a partially cutaway perspective view of the locking device of FIG. 1 showing the structural relationship between the circumferentially expandable body members and the axial expansion bolts that provide means for expansion of the body members.

FIG. 3 is a partially cutaway elevational view of a locking devoice in accordance with a preferred embodiment of the present invention illustrating the device locked within a socket on a trailer hitch thereby occluding the socket.

FIG. 4 is a left end view of a customized key for the locking device of the present invention shown in side view in FIG. 5.

FIG. 5 is a side view of a customized key for the locking device of the present invention.

FIG. 6 is a right end view of the customized key for the locking device of the present invention shown in left end view in FIG. 4 and side view in FIG. 5, FIG. 6 illustrating one spatial arrangement of the tines for the working end of the key.

FIG. 7 is a top view of a locking device in accordance with the present invention.

FIG. 8 is a side view of the locking device shown in FIG. 7.

FIG. 9 is a bottom view of the locking device shown in FIGS. 7 and 8 showing the receptacle for the key.

FIG. 10 is a side view of the axial expansion assembly of the locking device of the present invention.

### DESCRIPTION OF THE PREFERRED EMBODIMENTS

While the locking device of the present invention is described for use with a trailer hitch having a socket-type receptacle thereon adapted to receive a towing ball mounted on a vehicle, it will be obvious to the skilled artisan that the general idea of an expandable locking device presented herein can be adapted to occlude the ball-receiving hole in the ring of a ring-type trailer hitch. Accordingly, while the expandable locking device of present invention is intended for use with a socket-type trailer hitch, it is understood that the shape of the expandable occluding member can be modified to lockingly occlude the opening in a ring-type trailer hitch.

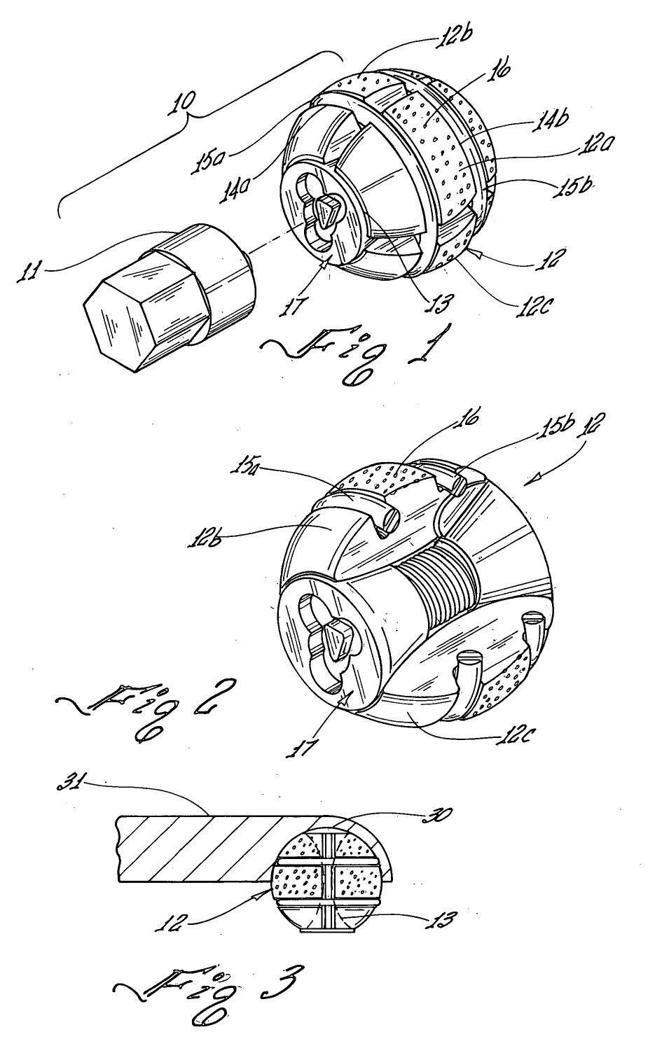

Turning now to FIGS. 1 and 2, an expandable locking device 10 adapted to occlude the socket of a socket-type trailer hitch is shown in perspective view with the key 11 removed from the expandable body member 12. The expandable body member 12 is substantially spherical with an axial bore 13 defining a longitudinal axis and cut longitudinally to form a plurality of segments, preferably four segments 12a-12d, only three segments 12a-12c being visible in FIG. 1. The expandable body member 12 has at least one, and more preferably two, transverse annular grooves 14a and 14b on the outer surface thereof. The grooves 14a and 14b serve to house elastically deformable “O”-rings 15a and 15b therewithin. The elastically deformable rings 15a and 15b are preferably made of an elastomer such as neoprene and are operable for holding the segments 12a-12din juxtaposition to maintain a substantially spherical body. The axial bore 13 is conically tapered outwardly on both ends thereof as illustrated by the dotted lines in FIGS. 3 and 8. The conically tapered portions of the axial bore are mirror images of one another and have a greatest diameter at the outermost ends thereof. Preferably, at least a portion of the outer surface 16 of the segments 12a-12d is rough-textured to securely engage the inner surface of a socket on a trailer hitch when the expandable member 12 is expanded therewithin.

An axial expansion assembly, generally indicated at numeral 17, and shown in detail in FIG. 10, is disposed within the axial bore 13. The axial expansion assembly 17 is operable for urging the segments 12a-12d outwardly from the axial bore 13 when the tapered nut 101 (FIG. 10) is advanced over the threaded shaft 102 of a fixed bolt 100 by rotation thereof using the key 11 as will be discussed below.

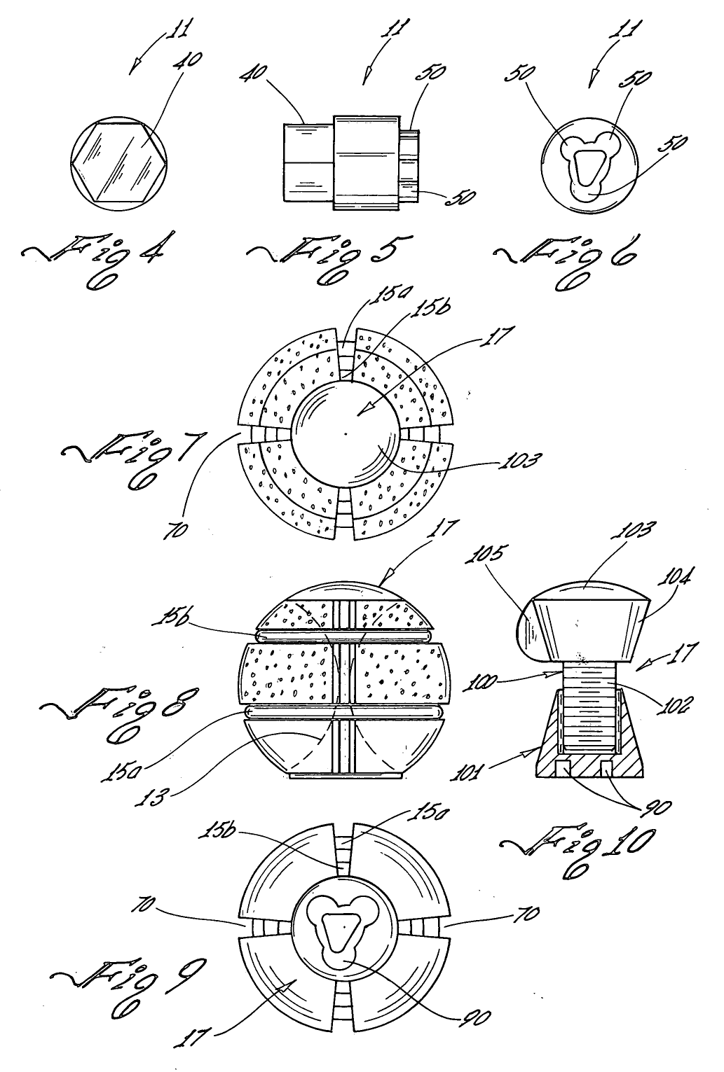

FIG. 3 is a partially cutaway elevational view of the expandable member 12 of the locking device 10 illustrating the expandable member 12 locked within a socket 30 on a trailer hitch 31 thereby occluding the socket. The expandable member 12, once expanded within the socket 30, cannot be removed without the use of a key 11. An exemplary key 11 operable for axially expanding and contracting the expandable member 12 is shown in left, elevational (side) and right views in FIGS. 4-6 respectively. One end of the key 11 has wrench attachment means 40 such as a hexagonal head operable for receiving and engaging a torque wrench or similar tool. Tines 50 having a spatial relationship with respect to one another project outwardly from the opposing end of the key 11 as shown in FIGS. 5 and 6. The spatial arrangement of the tines 50 is configured to matingly engage tine receptacles 90 on the outermost end of tapered nut 101 (FIGS. 9 and 10) in order to operate the axial expansion assembly 17.

The axial expansion assembly 17 is shown in side view in FIG. 10. The assembly 17 comprises a fixed bolt 100 and a threaded tapered nut 101 having a tapered outer surface rotatably mounted on a threaded shaft 102 of the fixed bolt 100. The fixed bolt 100 has a preferably dome-shaped head 103 which is tapered inwardly on the outer lateral surface 104 thereof. A flange 105 integral with the head 103 of the fixed bolt 100 extends laterally from the outer surface 104 and is dimensioned to fit within a space 70 between segments 12a and 12b of the expandable member 12 when the fixed bolt 100 is disposed within the axial bore 13 of the expandable member 12. The purpose of the flange 105 is to prevent the fixed bolt 100 from turning when the tapered nut 101 is screwed onto the threaded shaft 102 of the fixed bolt 100.

In operation, the tapered nut 101 is removed from the threaded shaft 102 of fixed bolt 100 and the fixed bolt inserted into one end of the axial bore 13 of the expandable member 12. Prior to expansion, the expandable member 12 is maintained in a contracted spherical configuration by the elastically deformable rings 15a and 15b. The expandable member 12 is then inserted into the socket of the trailer hitch such that the threaded shaft 102 is accessible through the opposite end of the axial bore. The tapered nut 101 is then threaded onto the end of the shaft 102 and advanced thereonto. As the tapered nut 101 advances over the shaft through the axial bore toward the tapered head of the fixed bolt, the tapered outer surfaces of the head of the fixed bolt and the tapered nut, having a greatest diameter that is larger than the greatest diameter of the tapered ends of the axial bore, urge the segments outwardly against the elastic resistive force exerted by the deformable rings 15a and 15b until the rough-textured outer surface of the segments contact the inner surface of the socket. The tines 50 of the key 11 are inserted into the tine receptacles 90 on the tapered nut 101 and a torque wrench or similar device employed to turn the tapered nut and further advance the tapered nut over the shaft until the tapered nut cannot be further advanced and the outer surface of the segments 12a-d can be expanded no further within the socket. The key 11 is then removed from the expandable member. When fully expanded, the expandable member 12, cannot be removed from the socket without the use of a key 11 and an appropriate wrench.

While particular embodiments of the present invention have been illustrated and described, it would be obvious to those skilled in the art that various other changes and modifications can be made without departing from the spirit and scope of the invention. For example, the spherical expandable member can be replaced with a segmented pulley-shaped expandable member dimensioned to fit within the central opening of a ring-type hitch and expanded within the opening to lockingly occlude the central opening in the same manner as the spherical expandable member occludes a spherical socket of a trailer hitch. The present invention, in its most general form, discloses an expandable member that can be placed within a socket on a trailer hitch, thereafter to be expanded to form a locking engagement with the socket and prevent the insertion of a towing ball into the socket until the expandable member is removed. Expansion means for expanding and contracting the expandable member within the socket other than the expansion assembly described herein may be employed, but such other expansion means are contemplated by the present inventor and are considered to be within the scope of the invention. It is therefore intended to cover in the appended claims all such changes and modifications that are within the scope of this invention.

What is claimed is:

1. A locking device operable for occluding a socket in a trailer hitch wherein the socket is adapted to matingly engage a spherical towing ball, the locking device comprising: (a) a substantially spherical expandable member adapted to fit within said socket, said expandable member having an axial bore, said axial bore defining a longitudinal axis; (b) an expansion assembly adapted to fit within said axial bore, said expansion assembly thereafter providing means for expanding said expandable member when a key engages said locking assembly and is rotated; and (c) a key operable for engaging said locking assembly.

2. The locking device of claim 1 wherein said axial bore is conically tapered outwardly on opposing ends thereof and wherein said expansion assembly comprises a fixed bolt having a conically tapered head with a threaded shaft projecting therefrom and a threaded, tapered nut having a conically tapered outer surface adapted to threadingly engage said threaded shaft.

3. The locking device of claim 2 wherein said conically tapered ends of said axial bore are mirror images of one another and have a greatest diameter.

4. The locking device of claim 3 wherein said expandable member is partitioned longitudinally into a plurality of segments and wherein adjacent segments have a slot therebetween.

5. The locking device of claim 4 wherein said conical head of said fixed bolt has a flange projecting laterally therefrom dimensioned to fit within said slot between two adjacent said segments.

6. The locking device of claim 5 further comprising at least one elastically deformable ring disposed within a transverse groove on an outer surface of said expandable member, said ring being operable for maintaining said segments in a substantially spherical configuration.

7. A locking device operable for occluding a socket in a trailer hitch wherein the socket is adapted to matingly engage a spherical towing ball comprising: (a) an expandable member adapted to fit within and conform to an inner surface of said socket; and (b) expansion means operable for expanding said expandable member within said socket to occlude said socket.
